(19) United States
(12) Patent Application Publication
(10) Pub. No.: US 2024/0208262 A1
(43) Pub. Date: Jun. 27, 2024

(54) WHEEL COMPONENT, METHOD OF MANUFACTURING, AND TOOL DEVICE

(71) Applicant: DT SWISS INC., Grand Junction, CO (US)

(72) Inventors: Fabian BECKER, Biel (CH); Michael MÜLLER, Icking (DE); Thomas GASSER, Detligen (CH); Martin WALTHERT, Aarberg (CH)

(21) Appl. No.: 18/526,347

(22) Filed: Dec. 1, 2023

(30) Foreign Application Priority Data
Dec. 23, 2022 (DE) 10 2022 134 718.4

(51) Int. Cl. B60B 1/00; B29C 45/00; B29C 45/13; B29C 45/17; B29C 45/22; B29C 45/26; B29C 45/33; B60B 1/12; B60B 1/14; B60B 21/02; B60B 21/06

(52) U.S. Cl. CPC B60B 1/003; B29C 45/0005; B29C 45/13; B29C 45/1706; B29C 45/1734; B29C 45/22; B29C 45/2602; B29C 45/2626; B29C 45/2669; B29C 45/33; B60B 1/12; B60B 1/14; B60B 21/025; B60B 21/062; B29C 2045/0089; B29C 2045/2683; B29L 2031/3091; B60B 2310/204; B60B 2360/341

(57) ABSTRACT

A wheel component, method, and tool device for a bicycle, including a plurality of integrally interconnected component parts, which form a spoked rim, wherein the rim and spokes are manufactured of a fibrous composite material by an injection molding process with fluid injection, wherein the liquefied fibrous composite material is injected into a cavity of a tool device, and a fluid is injected into the partially liquid fibrous composite material within the cavity to form at least one hollow space within the component part. A further component part forming a spoke, is manufactured by an injection molding process, wherein a mold core device for forming a hollow space within the spoke is disposed within a further cavity of the tool device. The fibrous composite material is injected into the further cavity. The mold core device is retracted from the fibrous composite material to form a cavity in the spoke.

### BACKGROUND

The invention relates to a wheel component for an at least partially muscle-powered vehicle, in particular, a bicycle, comprising a plurality of component parts, which are integrally interconnected and which form a rim with a plurality of integral spokes, wherein the rim and the spokes are manufactured of a fibrous composite material by injection molding. The invention also relates to a method of manufacturing and a tool device for manufacturing a wheel component.

The prior art has disclosed a variety of wheel components manufactured by an injection molding process:

U.S. Pat. No. 5,415,463 has disclosed a rim for a bicycle of fiber glass with fiber reinforcement, comprising a hollow space. The rim is manufactured by an injection molding process, wherein a core of a resin or of a metal having a low melting point is placed in a casting mold. Thereafter, liquefied fiber glass with a fiber reinforcement is injected into the casting mold. As the fiber glass respectively the glass fibers has/have solidified, the core is liquefied by heating, wherein the fiber glass remains solid. The liquid core material can drain off of the finished component through apertures.

A drawback of this manufacturing method is that a suitable core must first be manufactured for each rim. Accurately fitting cores achieve high dimensional consistency. Wheels thus manufactured can be both comparatively lightweight and also sturdy. Reproducible manufacture is basically possible as well. A considerable drawback is, however, that the core is “lost” when manufacturing the rim, and that the core must be precisely positioned. Cores from cost-effective manufacture do not have the required dimensional consistency. By way of compensating for these tolerances, the tools may already be built with higher wall thicknesses. This has negative effects on the weight of the rim. Alternately, the cores must be manufactured to have a very close fit and must be positioned highly accurately, which considerably increases the complexity. Another drawback of the method using a “lost core” is also the high time overhead. This is why this known method is not suitable for series manufacture of wheel components.

US 2007/0 134 455 A1 and JP H08-309 780 A have disclosed methods of manufacturing wheels of fibrous composite materials. These methods involve first, injecting a liquid fibrous composite material into a mold, so that the circumferential rim and the radially aligned spokes are filled with a fibrous composite material. For weight reduction, a fluid is thereafter injected into the fibrous composite material while it is still liquid, to expel that portion of the fibrous composite material which is not yet solidified. This forms hollow spaces both in the rim and in the spokes to thus reduce the weight. The remaining wall thickness can be influenced by selecting the fluid pressure and the time of introducing the fluid. Basically, the system is functional, and operational wheels can be manufactured. It is a drawback, however, that the wall thickness must be consistently dimensioned such that the wheel can reliably withstand the operational loads. Therefore, the wall must be provided with a high thickness so as to result in a high weight. For high quality wheels of fibrous composite materials, the weight is as a rule too high, or the stability under load is too low.

It is therefore the object of the present invention to provide a wheel component, a method of manufacturing, and a tool device for manufacturing a wheel component for an at least partially muscle-powered vehicle, in particular, a bicycle, which has a low weight and which can be produced in series, providing process stability and cost efficiency.

### SUMMARY

A wheel component according to the invention for an at least partially muscle-powered vehicle, in particular, a bicycle, comprises a plurality of component parts, which are integrally interconnected, forming a rim with a plurality of integral spokes. The rim and the spokes are manufactured of a fibrous composite material by injection molding. The component parts of the rim are at least partially manufactured by an injection molding process involving fluid injection, comprising at least the following process steps:
the at least partially liquefied, and, in particular, plasticized, fibrous composite material is injected into at least one cavity in a tool device;
at least one fluid is injected into the at least partially liquid (injected) fibrous composite material within the cavity, to form at least one hollow space within the component part.

At least one further component part, forming at least part of a spoke (or the entire spoke), is at least partially formed by the following process steps:
within the at least one further cavity of the tool device, a mold core device is disposed for forming at least one hollow space within the further component part;
the fibrous composite material is injected into the at least one further cavity for forming the other component part;
the mold core device is retracted from the at least partially solidified fibrous composite material to form a cavity in the spoke.

The wheel component according to the invention has many advantages. A considerable advantage of the wheel component according to the invention is that the substantially closed hollow space in the rim is formed by injecting a fluid into the at least partially liquid fibrous composite material. In particular, a “lost core” for forming the hollow space can thus be dispensed with. This allows particularly cost-effective manufacture of the component parts of the rim with a hollow space. Selecting the parameters of material, temperature, pressure, fluid, etc., provides options for specifically controlling the wall thickness of the component parts, which achieve for one, a high stability under load, and for another, a (still) lower weight.

Due to manufacturing the component parts, which form the spokes integrally with the rim, by means of a mold core device (provided for automatic insertion and retraction or extraction), the spokes can be manufactured very precisely and cost-effectively. The straight spokes, in particular, have a constant cross section over at least a major portion of their length. The cross section is constant over preferably at least 50% and, in particular, more than 66% or more than 75% or more than 80% (or 90% or more) of the length of the spoke.

In particular, does the inner diameter and/or the outer diameter and/or the wall thickness of a spoke vary over 50% and, in particular, more than 66% or more than 75% or more than 80% of the length of the spoke, by less than 30% or preferably less than 20% or less than 10%. The deviations may be less than 5%. In particular, does the wall thickness of a spoke vary over 50% and, in particular, more than 66% or more than 75% or more than 80% of the length of the spoke, by less than 1 mm or preferably less than 0.75 mm or less than 0.5 mm or by less than 0.25 mm.

The straight or linear configuration of the spokes allows insertion of retractable and extendable cores in the shape of reusable mold core devices, so as to achieve a particularly accurate fit and reproducibility. The spokes which in normal, regular use are exposed to high and constantly varying loads, can be manufactured cost-effectively, reproducibly, by means of (frequently) re-usable mold core devices, while even the component parts forming the rim can be manufactured cost-effectively, not using any lost cores. Due to retracting and extending the (re-usable) mold core devices, the mold core devices can also be positioned automatically and reproducibly (and highly accurately).

Moreover, using the fluid results in a smooth outline of the wall surface of the hollow space, absent any projections or corners and edges and projections along an outline of the surface, so that any taken-up and operative forces can be evenly received and dissipated. This furthermore provides the component part with an even and particularly thin wall, so as to advantageously enable a (particularly) low weight of the component part.

Preferably, the fluid injected is (at least) one liquid and, in particular, water. Prior to injecting the liquid (in particular, water), a (small) gas volume such as a (small) air volume is injected. Another inert gas is likewise conceivable. One advantage of injecting a gas volume is that it serves as a gas cushion. The gas volume, in particular, serves as an insulating layer between the fluid and the fibrous composite material, which is still liquid, to avoid fast solidification at the flow front. The gas volume is small compared to the entirety of the injected fluid volume (in particular, less than 1/10).

Furthermore, due to the fluid injection in the injection molding process, the wheel component can be produced in series, providing process stability.

A further advantage is that the injection molding process also provides for a very high surface quality of the outer surfaces of the component part, so that after injection molding, the wheel component does not require much post-processing or nearly none at all. As a rule, however, sprues, spills, and mold separation points and the like, will be after-treated respectively finished.

Moreover, component parts can be manufactured with hollow spaces with complex geometries, such as branching or cross sections curving along an outline, and with cross sections varying along an outline. There is no need for manufacturing specific cores.

Preferably, the fibrous composite material comprises at least carbon fibers and/or glass fibers and at least one substrate material.

Advantageously, (relatively) short-fiber fibrous composite materials or fibrous composite materials including medium length fibers are used, which can be processed in an injection molding process, and can particularly well accommodate and transmit dynamic loads, and have a homogeneous material quality. The fibrous composite material, in particular, comprises at least one fibrous composite material comprising at least one polyamide, such as PA66, PA6.6 or PEEK. These fibrous composite materials are preferably completely recyclable. This is particularly advantageous and enables a sustained product circle.

Preferably, fibrous composite materials with fibers of a length between 0.05 mm and 40 mm are used. If short fiber-reinforced materials are used, the average fiber length is preferably about 0.2-0.4 mm.

Particularly preferably, fibrous composite materials with fibers of an (average) length between 0.2 mm and 15 mm are used. In specific configurations, fibrous composite materials with fiber proportions of more than 25% or more than 50% having a length of more than 2 mm or more than 5 mm and less than 20 mm, have been used. Preferably, (long fiber-reinforced) fibrous composite materials with fibers in a length of (average) ca. 12 mm are used. There are indications that this improves the mechanical properties.

Another considerable advantage is a homogeneous, or more homogeneous, material quality. Another advantage is that a (locally) specific orientation of the fibers (or short fibers) is possible in the process.

The hollow space comprises, in particular, (in the component parts of the rim) at least one opening reaching through the wall of the component part, and preferably at least two openings, which may be generated by injecting the fluid for forming the hollow space and by the fluid exiting from the hollow space. The hollow space may comprise more than two openings.

Preferably, at least two component parts are comprised. The component parts are, in particular, integrally interconnected. The component parts may advantageously be interconnected immediately during manufacture, by injecting the fibrous composite material into all the cavities (simultaneously or nearly simultaneously), at least before the fibrous composite material in a cavity is solidified. Particularly advantageously, this achieves homogeneous material properties, and, in particular, a homogeneous material structure, of all the component parts of the wheel component, wherein no joints or parting lines are formed between the component parts, which might adversely affect the stability of the wheel component.

Particularly preferably, the hollow spaces of the (at least two) component parts are (at least partially) separate from one another. The separate hollow spaces, in particular, do not have any connection. Preferably, a wall is configured between the hollow spaces (at least in sections). Advantageously, the component parts and, in particular, the hollow spaces can thus be manufactured and, in particular, formed separately and independently from one another, in particular, by different methods. Alternately, two or more hollow spaces may be interconnected, forming a continuous hollow space which extends through a number of component parts.

At least one component part (of the at least two component parts) is manufactured by an injection molding process with fluid injection, and at least one other, in particular, a further, component part is manufactured according to another, in particular, further, method, likewise an injection molding process, and differing in at least one process step from the injection molding process involving fluid injection. Preferably, with the other method, no fluid is injected for forming a hollow space. Advantageously, the advantages of different injection molding processes are utilized for manufacturing the wheel components. Advantageously, these at least two component parts are likewise integrally interconnected.

Preferably, a mold core device with at least one permanent, in particular, metallic, mold core is used. The mold core device, in particular, comprises at least one rod-like mold core, which can be retracted from the solidified component part. Advantageously, forming a hollow space by means of a permanent mold core device can be advantageously used for hollow spaces with a straight shape and, in particular, a constant cross section. These process steps can advantageously be connected with the injection molding process involving fluid injection. Preferably, the hollow spaces formed by the mold core device are delimited and, in particular, separated from the hollow spaces, which are formed by fluid injection. Advantageously, at least one spoke of a wheel component can be manufactured by the method.

Preferably, at least one other, and, in particular, a further, component part is manufactured from a fibrous composite material, which is at least partially manufactured by an injection molding process, which comprises at least the following steps:
at least one hub body (insert) is received and centered in the tool device, in particular, in a takeup device, so that the hub body is at least partially disposed in another, and, in particular, a further, cavity;
the at least partially liquefied and, in particular, plasticized fibrous composite material is injected into the other, and, in particular, further, cavity of the tool device, so that the hub body is (at least partially) coated in the fibrous composite material, and, in particular, cast in the component part.

Advantageously, at least the hub body (or other inserts as well) may be incorporated in the component part. Advantageously, already prior to manufacturing the component part, the hub body may be machined completely by an injection molding process. This incorporates into the wheel component e.g. functional surfaces having narrow tolerances, such as fits or alignments, immediately during manufacturing, requiring no further subsequent machining. In this way, the takeup device thus, in particular, aligns and, in particular, centers the hub body in the cavity. Advantageously, at least one component part configured as a hub of the wheel component can be manufactured by the other method.

It is also possible to cast two (or more) hub body components as inserts. For example, two or more separate hub body components can be inserted in a defined position.

Preferably, the hub body has at least one mold element, which is at least partially enclosed in the fibrous composite material. Advantageously, the mold part forms at least one form closure between the hub body and the solidified fibrous composite material. Advantageously, the mold element ensures a form-closed force transmission. Preferably, the mold element is configured as a notch, groove, lug, or wing, on the hub body. The mold element, in particular, extends at least partially transverse to the direction of load application of the hub body (this means, in particular, that the mold element forms the hub body locally non-round). Preferably, the mold element enables a safe force transmission between the hub body and the fibrous composite material, even in the case of high loads and, in particular, in the case of thermal expansions.

The hub body is, in particular, manufactured of a metal, such as aluminum, or at least comprises aluminum. Bearing seats, preferably for ball bearings or for sliding half bearings, are expediently configured on the hub body. Preferably, the hub body may also comprise further functional components, such as a freewheel device or the like. The listing is exemplary only, and not final.

Preferably, at least one component part is configured as a component part selected from a group comprising at least one spoke, at least one rim segment of a rim, a rim and at least one hub of a wheel. Advantageously, such a wheel component may be configured as a substantially closed and (locally) tube-like hollow body structure, which can be produced to be particularly stable and lightweight and in series, providing process stability.

Preferably, a rim segment comprises two opposed rim flanks with a rim well and a rim base, and preferably rim flanges, on the two rim flanks.

In a suitable configuration, the wheel component is configured as a wheel, e.g. a front wheel or a rear wheel. The wheel has a plurality of component parts. The component parts comprise (at least) one circumferentially closed rim with a plurality of rim segments, and a plurality of spokes, and, in particular, a hub. At least one rim segment is, in particular, manufactured by an injection molding process with fluid injection. The other, and, in particular, further, component parts, i.e. the component parts configured as spokes, are manufactured by a different (injection molding) process. Preferably, the wheel comprises between three and ten spokes. Particularly advantageously, the hollow spaces of the individual component parts are separate from one another, so as to provide a particularly stable hollow space structure with a large number of bracings. Particularly advantageously, the wheel therefore has high stability under load and a low weight. The wheel can be manufactured in series manufacture, showing process stability.

The component parts are, in particular, shaped and integrally interconnected in the manufacturing process, so that no subsequent assembly of multiple different component parts is required. At the same time, a hub body may be received or provided in the hub, with machined, functional surfaces such as bearing seats. The pertaining surfaces of the hub body are first machined with precision. For example, a bearing seat is machined first.

The method according to the invention serves to manufacture a wheel component for at least partially muscle-powered vehicles and, in particular, bicycles with a plurality of component parts which are integrally interconnected and form a rim with a plurality of integrally configured spokes, wherein the rim and the spokes are manufactured of at least one fibrous composite material by injection molding. The method comprises at least the following process steps:
injecting the at least partially liquefied and, in particular, plasticized fibrous composite material into at least one cavity in a tool device;
injecting at least one fluid into the at least partially liquid fibrous composite material within the cavity, to form at least one hollow space within the at least partially solidified component part, to thus form the component parts of the rim.

At least one further component part, which forms at least part of a spoke, is manufactured by the following process steps:
within the at least one further cavity of the tool device, a mold core device is disposed for forming at least one hollow space within the further component part;
the fibrous composite material is injected into the at least one further cavity for forming the other component part;
the mold core device is retracted from the at least partially solidified fibrous composite material to form a cavity in the spoke.

The wheel component with the rim and the integrally interconnected spokes is removed from the tool device.

The method according to the invention has many advantages. It is a considerable advantage of the method according to the invention that no lost mold core is required for forming the hollow space, so that the method can be carried out cost-effectively in series manufacture. Advantageous specific embodiments of the method can be taken from the entire application.

Preferably, the fluid (in particular, water and first some gas) is injected when the fibrous composite material is at least partially solidified (directly) on a wall of the cavity and forms a wall of the component part. Preferably, the fibrous composite material is solidified along a substantial portion of the wall prior to injecting the fluid. Advantageously, a time offset between injecting the fibrous composite material and injecting the fluid presets a wall thickness of the component part, so as to allow manufacturing a wall with a defined wall thickness.

Suitably, the wall of the cavity is at least partially cooled, preferably by means of at least one cooling device. This allows, in particular, to preset a particularly precise wall thickness of the wall. Furthermore, the speed of the solidification process can be influenced, and preferably accelerated, by cooling by means of at least one cooling device.

Particularly preferably, the cavity is (quasi or nearly) completely filled with the fibrous composite material prior to injecting the fluid, so that the liquid fibrous composite material is at least displaced (at least) partially from the cavity by the injection of the fluid. In particular, is the displaced fibrous composite material displaced into (at least) one overflow volume, such as an overflow cavity. In particular, is the cavity filled at least 90%, 95%, 99% or even more, with fibrous composite material. Advantageously, at least the wall of the cavity substantially completely wetted before the fluid is injected. Advantageously, this ensures at least that any place in the cavity is provided with sufficient fibrous composite material for forming a continuous wall of a component part. Furthermore, the volume compensation can minimize, and, in particular, prevent, component stresses, in particular, due to shrinkage during the solidification process. Advantageously, the fibrous composite material displaced from the cavity can be re-used.

In particular, can the exit of displaced fibrous composite material be limited by a valve device having at least one movable control element, such as a mechanical slidegate, to optimize the manufacturing process. Preferably, the valve device at least partially prevents the fibrous composite material from draining into the overflow volume, at least while the fibrous composite material is injected.

Advantageously, the cavity is at least partially evacuated prior to, or at least during, the fluid injection. Advantageously, this enables to prevent any (gas) inclusions and defects in the component parts. Preferably, the cavity can be evacuated by at least one pump or the like.

Suitably, the tool device comprises at least two cavities for manufacturing two component parts. Preferably, the cavities are at least partially interconnected. Suitably, each cavity receives (separate) injections of fibrous composite material, so that the fibrous composite material bonds and an integral wheel component is formed from the two or more component parts.

In particular, is the fibrous composite material (nearly) simultaneously injected into each of the cavities, wherein the fibrous composite material in each of the cavities is at least partially liquid, so that it can combine with the other fibrous composite material (resulting in one single material). Particularly advantageously, a wheel component having multiple component parts can thus be formed, and showing no transition lines, seams or parting lines. In particular, do the component parts make seamless transitions, so that force flow between the component parts is not (adversely) affected.

Preferably, the fluid comprises at least one gas or a gas mixture, such as, in particular, air or an inert gas or a noble gas. Advantageously, a gas or a gas mixture can be compressed and can compensate for material shrinkage when the fibrous composite material solidifies. Suitably, the fluid comprises at least one liquid, in particular, water. Advantageously, liquids have a high heat capacity, so that the liquid fibrous composite material cools off faster. Advantageously, the fluid may be a mixture of at least one gas and a liquid, so that the advantages of gases and liquids can at least partially be combined.

In a further configuration of the invention, at least one projectile element may be provided in addition to the injected fluid, which projectile is at least partially urged by the fluid through the cavity with the liquid fibrous composite material, thus clearing the hollow space. Advantageously, this allows very precise presetting of the wall thickness, in particular, with large diameters of the hollow space.

The apparatus according to the invention with a tool device serves for manufacturing at least one wheel component for at least partially muscle-powered vehicles and, in particular, bicycles. The tool device serves to manufacture wheel components, each comprising a plurality of component parts, which component parts are integrally interconnected. The component parts form a rim and a plurality of integrally configured spokes, wherein the rim and the spokes are manufactured of a fibrous composite material by injection molding in the tool device. The tool device comprises, for configuring the component parts of the rim and the spokes, at least two molding devices, which form at least one (open or closed) cavity for forming a plurality of integrally interconnected component parts of the wheel component. For forming at least one component part of the rim, at least one injection port for injecting an at least partially liquid fibrous composite material and at least one injection nozzle for injecting at least one fluid is comprised within the (one) cavity for forming at least one hollow space within the component part of the rim. The tool device comprises at least one further cavity, which is connected with the cavity with the injection port. The tool device comprises a plurality of mold core devices, which, for forming hollow spaces in the spokes as component parts, are each retractable into, and extendable out of, the further cavities.

The apparatus according to the invention and the tool device also have many advantages. It is a considerable advantage of the tool device to enable the forming of a component part with at least one substantially closed hollow space, cost-effectively, and with process stability, in series manufacture. Advantageous specific embodiments of the tool device can be taken from the entire application.

Suitably, the molding devices comprise corresponding alignment units, by means of which the molding devices can be aligned to one another, to enable a defined geometry, and, in particular, outer contour, of the component parts.

Advantageously, at least one injection molding device is used with at least one heating device, at least for heating and liquefying the, in particular, granular fibrous composite material, and at least one conveyor device for injecting the at least partially liquid fibrous composite material into the cavity of the tool device. In particular, at least one plasticizing unit is comprised.

Preferably, the fibrous composite material is at least partially injected through a conveyor device, such as an auger device, a (hydraulic) pump, and/or by gravity.

Advantageously, the tool device comprises at least one cooling device, such as a water jacket, for cooling the molding devices and controlling the solidification process of the fibrous composite material.

The tool device, in particular, comprises at least one outlet nozzle disposed on the cavity and through which the injected fluid can exit back out of the hollow space.

Preferably, the tool device comprises at least one further cavity, which is connected with the cavity with the injection port. In particular, at least one mold core device is comprised, which can (at least partially) be disposed within the further cavity for forming a hollow space. Suitably, the mold core device can at least partially be inserted into the second cavity for forming a second hollow space, which is, in particular, separate from the first hollow space. Alternately or additionally, at least one takeup device for disposing, and, in particular, centering, at least one (separate) hub body or other insert is at least partially comprised within the further cavity. Advantageously, the hub body can be accommodated for casting in the third cavity. Advantageously, this carries out different injection molding processes with one tool device, in particular, simultaneously with manufacturing an integral wheel component.

The tool device, in particular, comprises at least two and preferably at least four and particularly preferably at least five, in particular, (nearly) identical, tool segments. Each tool segment comprises at least one cavity with at least one injection molding device with at least one injection nozzle. “Nearly identical” means, in particular, that the tool segments are the same or partially identical, other than e.g. a configuration of a valve gate or a takeup for a rim magnet (or similar small deviations). As a rule, e.g. exactly one segment is provided for the valve gate.

Preferably, the tool device comprises at least one overflow volume, such as an overflow cavity. Suitably, displaced fibrous composite material can be drained off through the cavity into the overflow volume, in particular, when forming a hollow space by fluid injection. Suitably, each tool segment comprises a separate overflow volume. Advantageously, the overflow volume enables in each tool segment, a short travel for compensating the fibrous composite material, so as to reduce, and, in particular, minimize, the probability of material defects due to shrinkage of the fibrous composite material during solidification of the fibrous composite material.

Alternately, the takeup volume may be formed by the injection molding device itself, so that the displaced liquid fibrous composite material is urged back into the injection molding device.

In a preferred specific embodiment, each tool segment of the tool device comprises at least one injection port for injecting an at least partially liquid fibrous composite material and at least one assigned injection nozzle for injecting at least one fluid for forming hollow spaces in the rim segments, and a mold core device provided for controlled traversing for forming the pertaining hollow space in a spoke.

Further advantages and features of the present invention can be taken from the exemplary embodiment which will be described below with reference to the enclosed figures.

### BRIEF DESCRIPTION OF THE DRAWINGS

The figures show in:

FIG. 1 a schematic illustration of a mountain bike with wheel components according to the invention, configured as wheels;

FIG. 2 a schematic illustration of a racing bicycle with wheel components according to the invention, configured as a wheel;

FIG. 3 a schematic, perspective view of a wheel component according to the invention, configured as a wheel for a bicycle;

FIG. 4 a schematic detail illustration of an enlarged part of the rim area of the wheel component according to the invention configured as a wheel;

FIG. 5a a schematic sectional view of a rim segment of the wheel component according to the invention configured as a wheel;

FIG. 5b a schematic, perspective view of a part of a wheel component according to the invention;

FIG. 6 a schematic detail illustration of an enlarged part around the hub of the wheel component according to the invention configured as a wheel;

FIG. 7 a schematic, perspective view of an insert configured as a hub body for casting in one of the component parts;

FIG. 8 a schematic view of a tool device according to the invention for manufacturing the wheel component according to the invention configured as a wheel;

FIG. 9 schematic illustrations to illustrate the function of the tool device and the method of manufacturing the wheel component according to the invention configured as a wheel;

FIG. 10 schematic illustrations of the injection molding process with fluid injection for manufacturing a component part configured as a rim segment, of the wheel component configured as a wheel.

### DETAILED DESCRIPTION

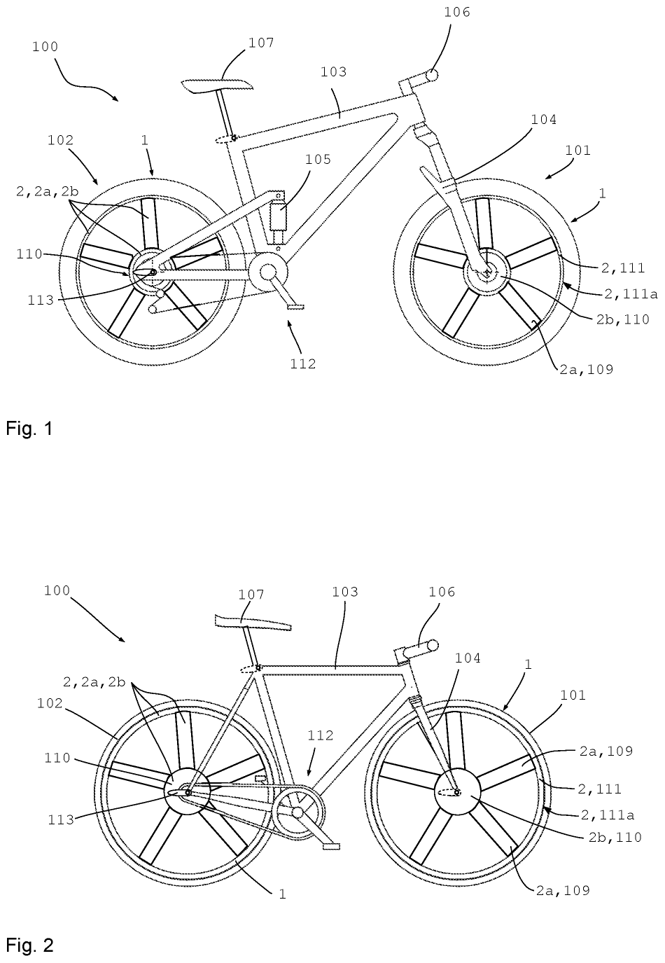

The FIGS. 1 and 2 show a mountain bike respectively a racing bicycle 100, each equipped with wheel components 1 according to the invention. The mountain bike or racing bicycle 100 is provided with a front wheel 101 and a rear wheel 102, which are configured as wheel components 1 according to the invention. The two wheels 101, 102 comprise spokes 109 to connect the rim 111a, which comprises multiple rim segments 111, with the hubs 110.

The wheel components 1 comprise component parts 2, 2a and 2b. The component parts 2 are rim segments 111 of the rim 111a, and the component parts 2a form the spokes 109, which connect the central component parts 2c (central component) integrally with the rim 111a.

A bicycle 100 comprises a frame 103, a handlebar 106, a saddle 107, a fork or suspension fork 104 and in the case of the mountain bike, a rear wheel damper 105 may be provided. A pedal crank 112 with pedals serves for driving. Optionally, an electric auxiliary drive may be provided on the pedal crank 112 and/or the wheels 101, 102. The hubs 110 of the wheels may be attached to the frame 103 by means of a clamping system 113 (for example a through axle or a quick release).

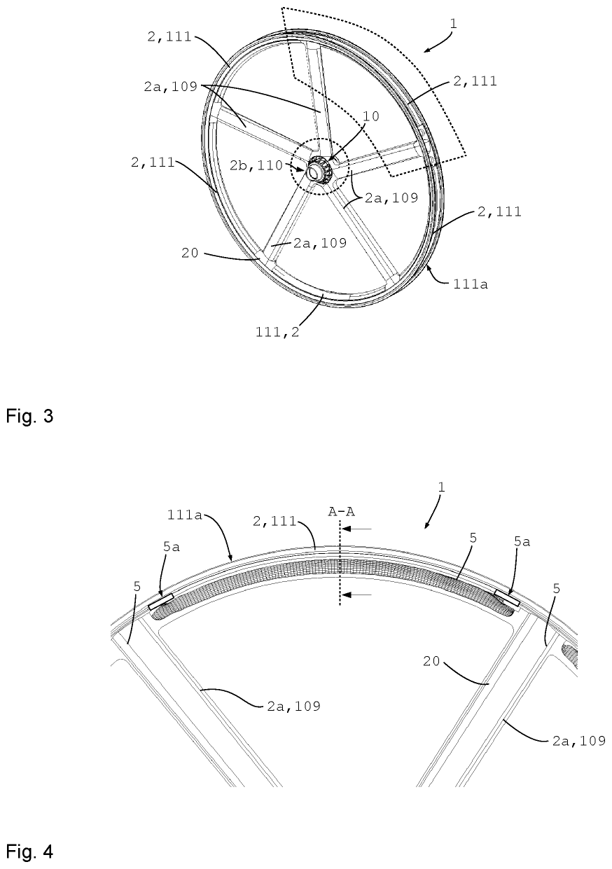

FIG. 3 shows a schematic, perspective view of a wheel component 1 according to the invention, which is configured as a wheel 101, 102 of a bicycle 100. The wheel component 1 comprises multiple component parts 2, 2a, 2b, all of which are manufactured by an injection molding process. The rim 111a comprises five rim segments 111. Each of the rim segments 111 is formed by a component part 2. All of the rim segments 111 are manufactured by an injection molding process with fluid injection. The spokes 109 and the hub 110 form component parts 2a, 2b, again manufactured by an injection molding process, but different from the injection molding process with fluid injection. The hub 110 furthermore comprises an insert configured as a hub body 10, which is cast in during manufacturing.

In all the configurations, the wheel component 1, and, in particular, the component parts 2 (rim segments 111), the component parts 2a (spokes 109), and the central component part 2c, are manufactured quasi concurrently with the cast-in hub body 10. “Quasi concurrently” means that these component parts are preferably all manufactured (in one process step), while and as long as all the component parts are located in one (shared) tool device. This means that the component parts are integrally configured within the tool device. The parts are not produced separately, taken out of the production, and then interconnected.

FIG. 4 shows a schematic detail illustration of an enlarged part of the rim area 111a of the wheel component 1 according to the invention configured as a wheel 100. The rim segment 111a illustrated extends between two spokes 109.

The component part 2 configured as a rim segment 111 is manufactured by an injection molding process with fluid injection, and therefore has a hollow space 5 formed by injection of a fluid 4, which extends along the peripheral direction of the rim 111a. The rim segment 111 or the component part 2 may be referred to as a peripheral component. Due to the manufacturing process, the hollow space 5 has two openings 5a reaching through the wall 7, for inlet and outlet of the injected fluid 4. The openings 5a can be closed airtight by plugs or end covers, not shown, so that tubeless tires can also be used in combination with the wheel component 1 according to the invention.

The spokes 109 as the component parts 2a, also comprise hollow spaces 5, each of which is shaped by means of a mold core device 52. The hollow spaces 5 of the component parts 2a are separated from one another by walls 7 and not connected, i.e., there is no continuous connection between the hollow spaces 5. Each mold core device 52 (FIG. 8) is retracted prior to injecting fibrous composite material and after solidification, extended again.

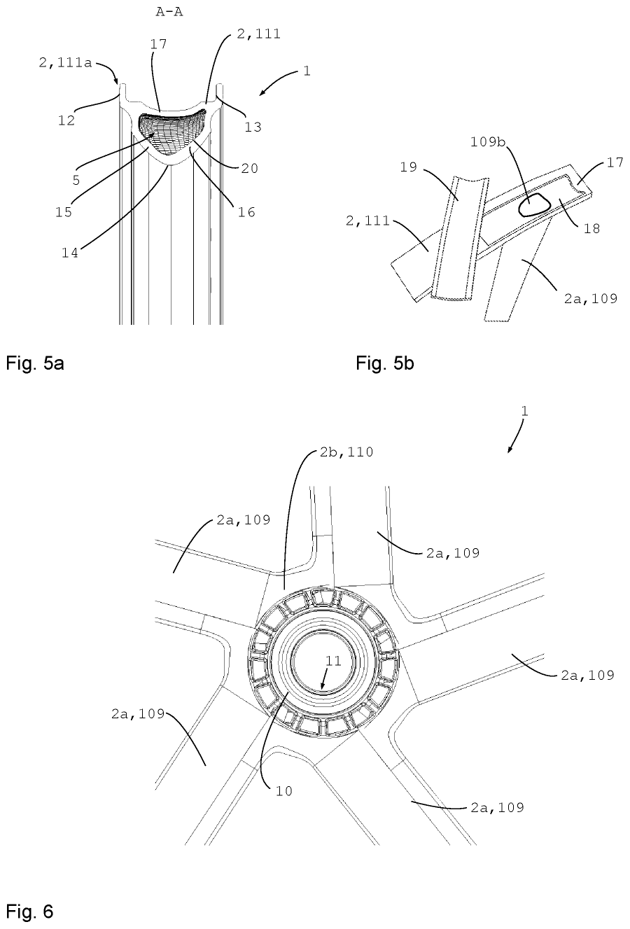

FIG. 5a shows a schematic sectional view of an enlarged part of the rim segment 111 of the wheel component 1 configured as a wheel 101, 102. A section through a component part 2 is shown, configured as a rim segment 111 of the rim 111a, see FIG. 4.

The rim segment 111 comprises two rim flanges 12, 13, a rim well 17, a rim base 14, and two rim flanks 15, 16. Between the rim base 14, the rim well 17 and the rim flanks 15, 16, the cavity 5 is configured, which is manufactured by an injection molding process with fluid injection, and which curves along the rim segment 111, in the plane of the drawing.

FIG. 5b shows a schematic, perspective view of a part of the wheel component 1, wherein a rim segment 111 is visible as a component part 2 and a spoke 109, as a component part 2a. The spoke 109 is configured hollow and comprises a hollow space 5 or a cavity 109b in the spoke 109. The component part 2 may also be referred to as a peripheral component, and the component part 2a, as a radial component. The hollow space 5 of the spoke 109 opens into the rim well 17. There, a takeup recess 18 is configured in the component part 2, which is configured in the closest fit possible immediately in the manufacturing process. After removing the wheel component 1 from the tool, a fitted end cover 19 is mounted and, in particular, glued on. The end cover 19 seals the takeup recess 18 and the spoke cavity 109b (airtight). The surface of the end cover 19 forms a portion of the rim well 17.

FIG. 6 shows a schematic detail illustration of an enlarged part around the hub 110 of the wheel component 1 according to the invention configured as a wheel 101, 102. The altogether five spokes 109 extend from the hub 110 radially (and linearly extended) outwardly. A hub body 10 is cast in the hub 110. The hub body 10 is manufactured of a lightweight aluminum, in which bearing seats 11 are configured by way of chip-removing machining. Thus, ball bearings can be inserted directly after manufacturing the wheel component 1. Subsequent, chip-removing machining of the wheel component 1 after manufacturing by an injection molding process is not required. As a rule, overflow cavities and e.g. sprues must be subsequently removed. Optionally, also webbing. As a rule, refinishing is limited to finishing the connection points such as sprues and overflow cavities.

The component parts 2, 2a, 2b are all manufactured by an injection molding process. The component parts 2, 2a are integrally interconnected, showing a homogeneous material structure, and not showing any seams or transition lines.

In all the configurations and embodiments, examinations by section determines that the cavities 109b in the spokes 109 have been formed or shaped by (smooth) mold core devices 52, inserted prior to injection molding and retracted or removed thereafter. The inner surface is configured (nearly perfectly or perfectly) symmetrical and remains unchanged over substantial portions of the length. The inside surfaces of the component parts 2 (rim segments 111) show considerably more surface variations, since as a rule the injected fluid causes less than perfectly smooth and symmetric surfaces in manufacturing, even though the surface quality on the inside is good and the wall thickness constancy meets requirements. In this respect there are measurable differences in different component parts 2, 2a, which determines the type of the (local) manufacturing method.

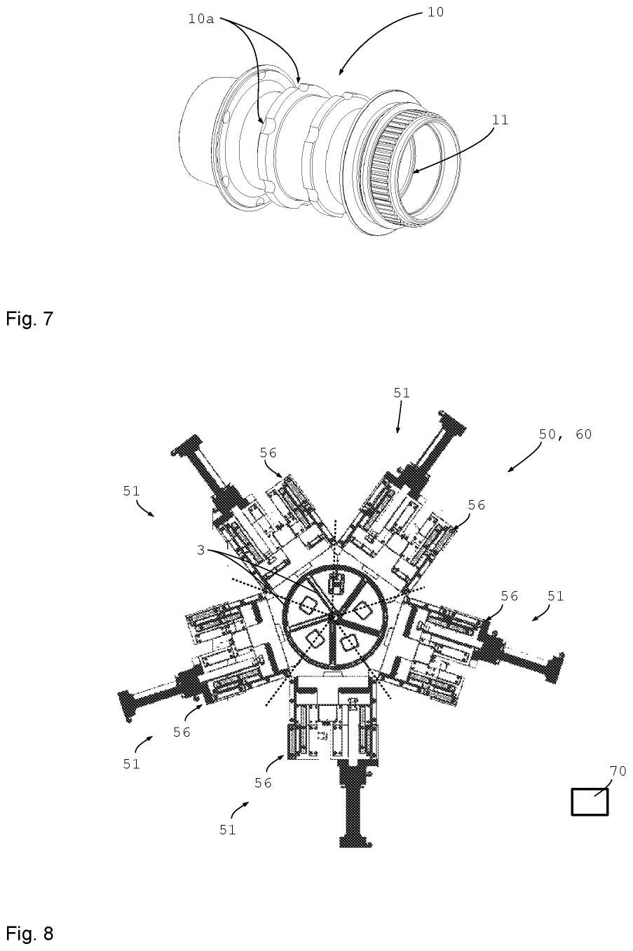

FIG. 7 shows a schematic, perspective view of a hub body 10 for casting into a component part 2a, manufactured by an injection molding process different from the injection molding process with fluid injection, see FIG. 6. The hub body 10 shows on the outside surface, moldings 10a configured as grooves or notches 10a. These moldings 10a are enclosed in the liquid fibrous composite material 20 during the injection molding process, generating a form closure, i.e. a form-closed connection. This ensures a functionally reliable force transmission between the hub body 10 and the fibrous composite material 20, in particular, in the case of high rotational forces or high transmitted forces, and independently of volume shrinkage during solidification of the fibrous composite material 20, or with thermal expansion.

FIG. 8 shows a schematic view of an apparatus 60 according to the invention with a tool device 50 for manufacturing a wheel component 1 according to the invention configured as a wheel 101, 102. In the inner area of the tool device 50, there is a plurality of interconnected cavities 3. In each cavity 3, a component part 2, 2a is manufactured by an injection molding process. Thus, the component parts 2, 2a are integrally interconnected (and, in particular, material-formed and of a single material). The apparatus 60 comprises a tool device 50, and in preferred configurations the apparatus 60 consists of a tool device 50. Optionally, a control device 70 (separate where appropriate) and further aggregates are provided.

The tool device 50 is subdivided in five equal tool segments 51. Each of the tool segments 51 comprises an injection molding device 56, through which the at least partially liquid fibrous composite material 20 can be injected, at least into the cavities 3 of the tool device 50 assigned to the tool segment 51. The quantity of the tool segments 51 corresponds to the quantity of the spokes 109 of the wheel component 1 configured as a wheel 101, 102. Furthermore, the injection molding device 56 comprises further elements such as a takeup volume 8, not shown in detail.

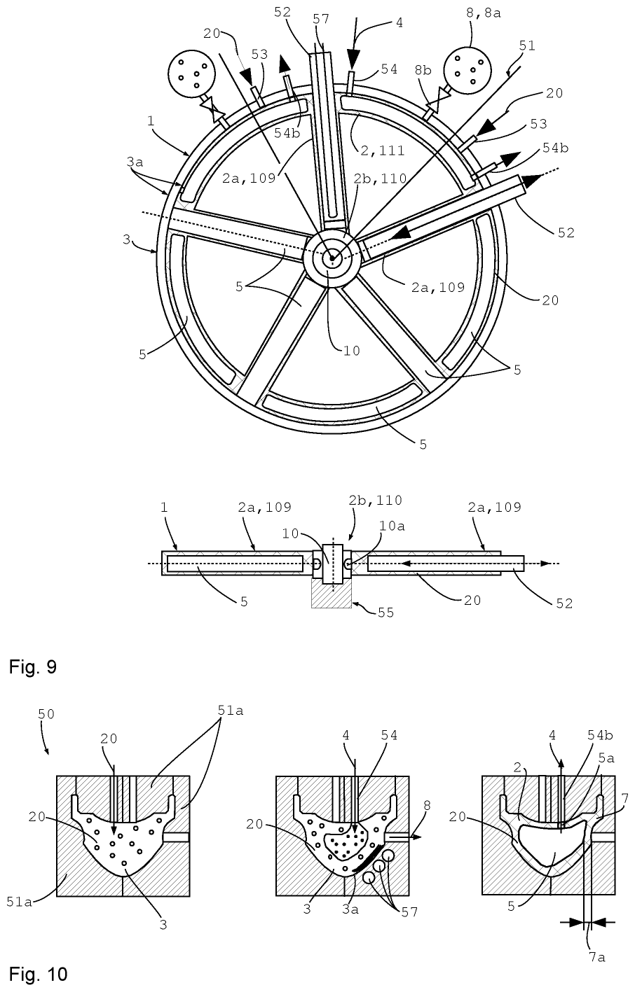

FIG. 9 shows schematic illustrations for visualising the method and, in particular, the function of the injection molding device 56 for manufacturing a wheel component 1 according to the invention configured as a wheel 101, 102. The component parts of the tool segment 51 are illustrated in detail for one of the altogether five equal tool segments 51.

The wheel component 1 configured as a wheel 101, 102 comprises component parts 2 manufactured by an injection molding process with fluid injection, and further component parts 2a manufactured by an injection molding process where no fluid 4 is injected, thus differing from the injection molding process with fluid injection in at least one process step.

The rim segments 111 are formed by component parts 2 manufactured by an injection molding process with fluid injection. The spokes 109 shown are formed by other component parts 2a, manufactured by an injection molding process, wherein a mold core device 52 is inserted into the cavity 3 for forming a hollow space 5. The component part 2a configured as a hub 110 comprises the insert configured as a hub body 10, which is cast in.

For manufacturing the wheel component 1 configured as a wheel 101, 102, the cavities 3 are configured such that the walls 3a of all the cavities 3 correspond to an outer surface of the wheel component 1. The cavities 3 are interconnected, so that the component parts 2, 2a, and also the resulting wheel component 1, are integrally configured.

For manufacturing the wheel component 1, a mold core device 52 is first inserted into the cavity 3, forming a component part 2a configured as a spoke 109. The geometry of the mold core device 52 determines the shape of the hollow space 5 within the component part 2a configured as a spoke 109. The mold core device 52 shown is configured as a slidegate, which is retracted into the cavity 3. The slidegate shows a cross section (e.g. round) so that the slidegate can be extended again (without any problems).

This slidegate preferably shows an oval or round cross section. Or, the cross section may be configured non-round or star-shaped. As a rule, the slidegate travels (only) linearly. Other than linear movement, however, a rotary motion is likewise conceivable, so that e.g. a helical cavity forms.

The hub body 10 is received centered by a takeup device 55 and oriented within one of the cavities 3.

The cavities 3 are evacuated through the outlet nozzle 54b by means of a pump, not shown. During evacuation, the at least partially liquefied fibrous composite material 20 is injected through the altogether five injection ports 53 of the tool device 5. The fibrous composite material 20 fills the cavities 3. All the cavities 3 are completely filled with fibrous composite material 20. When the fibrous composite material 20 is at least partially solidified on the wall 3a of the cavity 3, a fluid 4 for forming the hollow space 5 is injected into the rim segments 111 through the injection nozzles 54.

Due to the high heat capacity, water is used as the fluid 4. The fluid 4 displaces the fibrous composite material 20 into the overflow volumes 8, which are configured as overflow cavities 8a. The overflow cavities 8a can be adaptively selected by means of a valve device 8b configured as a control element 8b, comprising a mechanical slidegate. Alternately, the displaced fibrous composite material 20 may be displaced, and, in particular, urged back, into the injection port 53. Additionally, the walls 3a of the cavities 3 may be cooled by cooling devices 57 in the shape (e.g.) of a water jacket with water pipes, to control and accelerate the solidification process. By way of example, a water jacket of a cooling device 57 is configured, comprising a number of cooling pipes disposed within the mold core device 52.

The hub body 10 is enclosed by the fibrous composite material 20, the mold elements 10a establish a form closure between the hub body 10 and the fibrous composite material 20.

After solidification, all the component parts 2, 2a are integrally interconnected. The hollow spaces 5 manufactured by fluid injection and the mold core device 52 are separated from one another. The finished wheel component 1 can be removed and can, without any further post-processing or further manufacturing steps, be prepared for mounting, for example by inserting the bearings into the bearing seats 11.

FIG. 10 shows schematic illustrations of the injection molding process with fluid injection for manufacturing a component part 2 configured as a rim segment 111, of the wheel component 1 configured as a wheel 101, 102. The process flow is shown from the left to the right. In the first process step, the at least partially liquid fibrous composite material 20 is injected into the cavity 3, and the cavity 3 is entirely filled. The cavity 3 is formed by multiple molding devices 51a of the tool device 50.

When the fibrous composite material 20 is at least partially solidified on the wall 3a of the cavity 3, the fluid 4 is injected so as to form the hollow space 5. The solidification process is assisted by a cooling device 57 configured as a water jacket. Injecting the fluid 4 displaces a part of the still liquid fibrous composite material 20 into the overflow volume 8. The fluid 4 forms the hollow space 5 provided in the solidified component part 2.

The wall 7 shows an even, thin wall thickness 7a, which can be preset by controlled use of the cooling device 57. While the hollow space 5 forms, the injected fluid 4 is at least partially urged back out through the opening 5a in the hollow space 5. The injection nozzle 54 and the outlet nozzle 54b are represented in this Figure by the same opening.

While a particular embodiment of the present wheel component, method of manufacturing, and tool device have been described herein, it will be appreciated by those skilled in the art that changes and modifications may be made thereto without departing from the invention in its broader aspects and as set forth in the following claims.

List of reference numerals:

| | |
|---|---|
| 1 | wheel component |
| 2 | component part, circumferential component |
| 2a | other, further component part, radial component |
| 2b | central component part, central component |
| 3 | cavity |
| 3a | wall of 3 |
| 4 | fluid |
| 5 | hollow space |
| 5a | opening |
| 7 | wall of 2 |
| 7a | wall thickness of 7 |
| 8 | takeup volume |
| 8a | overflow cavity |
| 8b | valve device, control element |
| 10 | hub body, insert |
| 10a | mold element |
| 11 | bearing seat |
| 12, 13 | rim flange |
| 14 | rim base |
| 15, 16 | rim flank |
| 17 | rim well |
| 18 | takeup recess |
| 19 | end cover |
| 20 | fibrous composite material |
| 50 | tool device |
| 51 | tool segment |
| 51a | molding device |
| 52 | mold core device |
| 53 | injection port |
| 54 | injection nozzle |
| 54b | outlet nozzle |
| 55 | takeup device |
| 56 | injection molding device |
| 57 | cooling unit |
| 60 | apparatus |
| 70 | control device |
| 100 | bicycle |
| 101 | wheel, front wheel |
| 102 | wheel, rear wheel |
| 103 | frame |
| 104 | fork, suspension fork |
| 105 | rear wheel damper |
| 106 | handlebar, handle |
| 107 | saddle |
| 109 | spoke |
| 109b | cavity in the spoke, spoke cavity |
| 110 | hub |
| 111 | rim segment |
| 111a | rim |
| 111b | segment hollow space, hollow space in the rim segment |
| 112 | pedal crank |
| 113 | clamping system |

1. A wheel component for an at least partially muscle-powered vehicle, in particular a bicycle, comprising: a plurality of component parts, which are integrally interconnected and which form a rim with a plurality of integrally configured spokes, wherein the rim and the spokes are manufactured of a fibrous composite material by injection molding;
wherein the component parts of the rim are at least partially manufactured by an injection molding process with fluid injection, comprising at least the following process steps:
the at least partially liquefied fibrous composite material is injected into a cavity of a tool device; and
at least one fluid is injected into the at least partially liquid fibrous composite material within the cavity, to form at least one hollow space within the component part;
and wherein at least one further component part, which forms at least part of a spoke, is manufactured by an injection molding process, comprising at least the following process steps:
within the at least one further cavity of the tool device, a mold core device is disposed for forming at least one hollow space within the further component part;
the fibrous composite material is injected into the at least one further cavity for forming the other component part; and
the mold core device is retracted from the at least partially solidified fibrous composite material to form a cavity (109b) in the spoke.

2. The wheel component according to claim 1, wherein component parts of the spokes and the rim are integrally interconnected, and wherein at least some hollow spaces of the component parts of the rim are separated from one another.

3. The wheel component according to claim 1, wherein a hub body is received and centered on the tool device, so that the hub body is at least partially disposed within at least one further cavity,
and wherein the at least partially liquefied fibrous composite material is injected into the further cavity of the tool device, so that the hub body is coated by the fibrous composite material and is cast in a central component part,
and wherein the hub body comprises at least one mold element, which is enclosed by the fibrous composite material and forms at least one form closure between the hub body and the fibrous composite material of the central component part.

4. The wheel component according to claim 1, wherein at least one component part extends in the peripheral direction and is configured as a peripheral component and forms a rim segment of a rim,
and wherein at least one (other) component part is radially aligned as a radial component, and forms at least one part of a spoke, and wherein the hollow space in the spoke forms a spoke cavity,
and wherein a central component part with the accommodated hub body is connected with the peripheral component by way of the radial component.

5. The wheel component according to claim 4, wherein the hollow space in the spoke extends radially outwardly through the peripheral component, where a takeup recess is configured, which is covered by an end cover, and wherein the end cover forms a part of a rim well.

6. The wheel component according to claim 1, wherein the fibrous composite material comprises fibers of a length between 8 mm and 20 mm.

7. A method of manufacturing a wheel component for at least partially muscle-powered vehicles and in particular bicycles with a plurality of component parts, which are integrally interconnected and form a rim with a plurality of integrally configured spokes, wherein the rim and the spokes are manufactured of at least one fibrous composite material by injection molding, comprising at least the following process steps:
injecting the at least partially liquefied fibrous composite material into at least one cavity of a tool device; injecting at least one fluid into the at least partially liquid fibrous composite material within the cavity, to form at least one hollow space within the solidified component part, to thus form the component parts of the rim;
and wherein at least one further component part, which forms at least part of a spoke, is manufactured by way of the following process steps:
within the at least one further cavity of the tool device, a mold core device is disposed for forming at least one hollow space within the further component part;
the fibrous composite material is injected into the at least one further cavity for forming the other component part; and
the mold core device is retracted from the at least partially solidified fibrous composite material to form a cavity (109b) in the spoke;
the wheel component with the rim and the integrally interconnected spokes is removed from the tool device.

8. The method according to claim 7, wherein the fluid is injected when the fibrous composite material is at least partially solidified on a wall of the cavity and forms a wall of the component part, and wherein the wall of the cavity is at least partially cooled,
and wherein the cavity is completely filled with the fibrous composite material prior to injecting the fluid, so that the liquid fibrous composite material is at least partially displaced from the cavity into an overflow volume by way of injecting the fluid.

9. The method according to claim 7, wherein the tool device comprises at least two cavities for manufacturing two component parts, and wherein the cavities are interconnected, and wherein fibrous composite material is injected into each cavity, so that the fibrous composite material bonds to form an integral wheel component.

10. The method according to claim 7, wherein the fluid comprises a liquid such as water.

11. An apparatus with a tool device for manufacturing a wheel component for at least partially muscle-powered vehicles and in particular bicycles,
wherein the tool device serves to manufacture wheel components comprising: a plurality of component parts, wherein the component parts are integrally interconnected and form a rim and a plurality of integrally configured spokes, wherein the rim and the spokes are manufactured in the tool device of a fibrous composite material by injection molding,
wherein the tool device, for forming the component parts of the rim and the spokes, comprises at least two molding devices, which form cavities for forming a plurality of integrally interconnected component parts of the wheel component, wherein, for forming at least one component part of the rim, at least one injection port for injecting an at least partially liquid fibrous composite material and at least one injection nozzle for injecting at least one fluid is comprised within the one cavity for forming at least one hollow space within the component part of the rim;
and wherein the tool device comprises at least one further cavity, which is connected with the cavity with the injection port;
and wherein the tool device comprises a plurality of mold core devices, which, for forming hollow spaces in the spokes as component parts, are each retractable into, and extendable out of, the further cavities.

12. The apparatus with a tool device according to claim 11, comprising at least one takeup device to at least partially dispose a hub body within the further cavity.

13. The apparatus with a tool device according to claim 11, comprising at least four or five equal tool segments, wherein each tool segment comprises at least one cavity and at least one injection molding device with at least one injection nozzle for forming rim segments of the rim.

14. The apparatus with a tool device according to claim 11, wherein each tool segment comprises at least one separate overflow volume, in particular an overflow cavity.

15. The apparatus with a tool device according to claim 11, wherein each tool segment comprises at least one injection port for injecting an at least partially liquid fibrous composite material, and at least one assigned injection nozzle for injecting at least one fluid for forming hollow spaces in the rim segments, and a mold core device provided for controlled traversing for forming hollow spaces in the spokes.
